(19) United States
(12) Patent Application Publication
(10) Pub. No.: US 2003/0033991 A1
(43) Pub. Date: Feb. 20, 2003

(54) Portable hydrogen generation using metal emulsions

(76) Inventor: Christopher T. Cheng, Mountain View, CA (US)

Correspondence Address: Christopher T. Cheng, 260 West Dana Street, Mountian View, CA, 94041, US

(21) Appl. No.: 09/923,887

(22) Filed: Aug. 7, 2001

(51) Int. Cl. F02B 43/08

(52) U.S. Cl. 123/3

(57) ABSTRACT

A portable hydrogen generation system for operating a vehicle powered by either the hydrogen internal combustion engine or a fuel cell using active metals such as sodium potassium, magnesium, aluminum or iron in the form of an emulsion. In the case of sodium, potassium and magnesium, the metal is reacting with water. However, in the case of aluminum and iron, the metal is reacting with alkali hydroxide solutions. The system is orchestrated by a microprocessor in order to generate hydrogen on demand with a very high efficiency.

References Cited

| | | | |
|---|---|---|---|
| 3,683,622 | August 1972 | Von Krusenstierna | 60/207 |
| 4,155,712 | May 1979 | Taschek | 422/239 |
| 4,261,955 | April 1981 | Bailey, Jr et al | 422/239 |
| 4,356,163 | October 1982 | Davidson | 423/657 |
| 4,988,486 | January 1991 | Harris et al | 22/191 |
| 5,510,201 | April 1996 | Werth | 429/17 |
| 5,514,353 | May 1996 | Adhart | 422/239 |
| 5,593,640 | January 1997 | Long et al | 429/111 |
| 5,690,902 | Nov. 25, 1997 | Werth | 423/658 |
| 5,728,464 | Mar. 17, 1998 | Checketts | 428/403 |
| 5,817,157 | Oct. 6, 1998 | Checketts | 48/61 |
| 5,830,426 | Nov. 3, 1998 | Werth | 423/658 |

### FIELD OF INVENTION

The present invention pertains to a portable hydrogen generation system which can power any internal combustion engines on-board vehicles such as automobiles. Furthermore, this hydrogen-generation-system can supply hydrogen to feed fuel cells. The fuel to the portable hydrogen-generation-system comes in the form of emulsion that is consisted of metal powder pre-mixed with oil. The metal emulsion can be precisely injected into the hydrogen-generation-system base on demand. The hydrogen is generated from the reactions between alkaline metal such as sodium and the water or between alkaline hydroxide solution and the metal such as iron or aluminum.

### BACKGROUND OF THE INVENTION

It is well known that hydrogen can be used to fuel Internal combustion engines or to feed fuel cells, and it has been commercially produced as a byproduct from the chlorine-alkali electrolysis or in large scale through a steam-carbon reaction. However, hydrogen is bulky and a real challenge to store. This obstacle can be overcome by hydrogen generation on-situ and on demand delivery. Davidson has produced hydrogen from the reaction between an alkali metal and water as in U.S. Pat. No. 4,356,163. Davidson's patent does not show that metal in emulsion can facilitate the metering-on-demand and the precise injection into an internal combustion engine, as proposed in the present invention. The on demand hydrogen generation systems are exemplified by the patents of Taschek, U.S. Pat. No. 4,155,712 and Bailey, Jr., U.S. Pat. No. 4,261,955. These patents show systems that are unlike the present invention which uses a metal emulsion. The patent of Taschek utilizes a membrane to separate a water container from a metal hydride or alkali metal with water slowly diffusing through the membrane to achieve a chemical reaction. However, the system is unreliable. In the case of membrane rupture, all alkali metal or metal hydride would be instantly exposed to water and resulting in an un-controllable generation of the hydrogen. This is totally unsuitable for use in the automobiles and motor vehicles. Another drawback of the membrane is the possibility of membrane clog after prolonged use.

The use of hydrogen as fuel for internal combustion engines or for fuel cells to run an electric car is shown in a patent issued to Von Krusenstierna, U.S. Pat. No. 3,683,622. But it is unlike the present invention that use metal emulsions which can be metered and fed precisely on demand to the hydrogen generator. Harris, et al, in U.S. Pat. No. 4,988,486, use hydrochloric acid to react with a Pure metal to generate hydrogen. There, again no metal emulsion is involved.

In a patent to Werth, U.S. Pat. No. 5,510,201, activated iron is reacted with heated water for hydrogen generation. There is no role for metal emulsion to play. Long, et al, U.S. Pat. No. 5,539,640 and Adlhard, U.S. Pat. No. 5,514,353, seek to generate hydrogen from metal hydrides and water. The diffusion of water into metal hydride granules results in hydroxide or oxide which may results in resistance to water diffusion and an incomplete conversion of rather expensive materials. In the present invention, because of the stirrer in the reactor, complete conversion of metal to hydrogen can be achieved. Another example of the in-situ-hydrogen-generation for internal combustion engines is shown Werth U.S. Pat. No. 5,690,902. In Werth's patent, hydrogen is generated by the reaction of non-compressed packed-iron-powder with alkaline hydroxide as catalyst at temperatures lower than 250° C. However, the merit of present invention is that the quantity of iron or aluminum in emulsion form can be precisely metered into the reactor and completely reacted according to the demand of the internal combustion engine, has not been observed. Checketts' patents, U.S. Pat. Nos. 5,728,464 and 5,817,157 suggest that any active material, such as sodium, is coated with an impervious material, such as plastics or aluminum film. The pellet coating can be broken by an electrical current or a mechanical means, such as a knife, and then the sodium is exposed to water to generate hydrogen on-board of a motor vehicle. Werth's arrangement, unlike the present invention, can supply the fuel only in large increments, due to the sizes of the pellets, not continuously as in my present invention. Werth, in his U.S. Pat. No. 5,830,426, reacts iron with water in the presence of an alkali hydroxide as a catalyst to generate hydrogen. Then, it is used to feed a fuel cell. The electricity produced is utilized to run an electric car. That invention does not have the benefits the present invention can offer. Namely, the simplicity of the mechanical arrangement and the precision and continuity of metering the fuel according to the demand of the engine.

### BRIEF SUMMARY OF THE INVENTION

The principal object of the present invention is to provide a fuel for a in-situ-hydrogen-generation system using a metal emulsion that can be continuously metered and precisely fed into a reactor, in which the metal is rapidly and completely reacted with water or hydroxide solution. The hydrogen generated is used to operate an internal combustion engine or to fuel a fuel cell. The electricity generated from the fuel cell can be used to drive an electric car or other electrical devices.

Another object of the present invention is to prepare the metal fuel (finely divided iron or aluminum or alkali metals) in paste form to prevent pre-usage contamination of the metal by water vapor or oxygen in the air. The said paste (or emulsion) has a certain consistency to allow it to be fed or injected smoothly, precisely, and continuously. The metal fuel emulsion maybe contained in cartridges.

Still another object of the present invention is to provide for the said hydrogen generation system, a microprocessor controlled system to orchestrate the smooth operations of the metal to hydrogen conversion. The microprocessor timely opens and closes the delivery valves of emulsion cartridges according to the operating conditions of the internal combustion engine which the hydrogen generation system serves. It also controls the supply of water (or hydroxide solution) to the reactor and the discharging of the waste reaction products.

Still another object of the present invention is to provide a stirrer for the reacting tank to promote a complete reaction between the metal powder granules and water (or hydroxide solution). Thus, the rapid reaction and the complete conversion of the metal to hydrogen are assured.

### BRIEF DESCRIPTION OF THE DRAWING

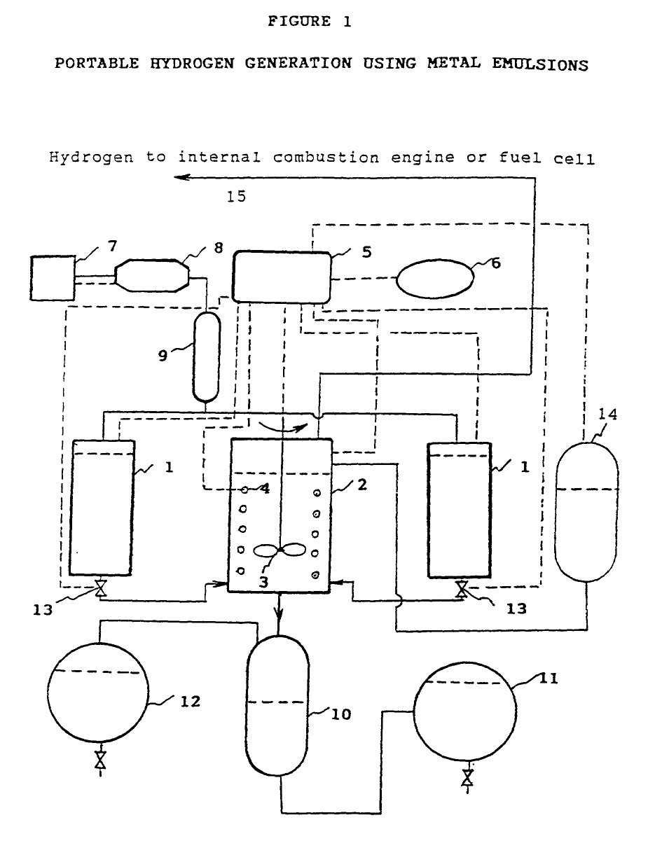

The above mentioned objects, features and advantages of the present invention will become more apparent from the attached drawing, FIG. 1 (on page 14), It shows that the flow diagram of the in-situ-hydrogen-generation system consists of a set of metal emulsion cartridges, 6 or 8 of them as a group, a reactor tank, a separating tank, an oily waste storage tank, an aqueous waste storage tank, a microprocessor control system and a status display. They are properly interconnected to insure a highly efficient operations of the in-situ-hydrogen-generation.

### DETAILED DESCRIPTION OF THE PRESENT INVENTION

References will now be made in detail to the preferred embodiment of the method of the present invention.

As shown in FIG. 1 (on page 14), 1 is a set of Metal emulsion cartridges which are surrounding the reactor tank, 2 all metal-emulsion cartridges with their individual delivery valves, 13 leading to the reactor tank, 2 the cartridges are connected on the intake end with compressed air reservoir, 8 through a desiccator, 9 the reactor tank is connected to the fresh water tank, 14 and the separation tank, 10 waste stream is separating here into two layers; the upper oily layer bleeds into the waste oil storage, 12 and the lower layer of alkali solution and the reacting products is discharged into an aqueous waste storage tank, 11 the whole system is controlled by a microprocessor subsystem, 5 the operating status and conditions are displayed on a liquid crystal display (LCD), 6 each metal-emulsion cartridge is provided with a pressure sensor. The microprocessor processes the signals from all pressure sensors and then issues commands to all parts of the system through the dotted lines.

The operation of the system is as follows: when the engine is starting or running, a suction is building up in the hydrogen delivering line, 15, and the pressure in the reactor tank, 2, is lowered. Since the pressure on top of each cartridge is kept constant with the air compressor through the compressed air reservoir, 7, and desiccator, 9, in use and the reactor tank, 2. When the microprocessor senses the pressure difference, a command is issued to open the delivering valve of the cartridge in use. The rate of metal emulsions flowing into the reactor is exactly proportional to the pressure difference. The feed rate of metal emulsions corresponds differently and proportionally to the engine's starting, idling and acceleration. The stirrer, 3, in the reactor provides a vigorous mixing effect to break up the metal-oil emulsion and to promote complete rapid reaction between the fuel metal and water or hydroxide solution. Thus, the complete utilization of the fuel metal is insured.

The microprocessor keeps track of the metal-emulsion content of the cartridge in use continuously. When one cartridge is exhausted, it closes the delivery valve of that cartridge, at the same time, opens the delivering valve of the next cartridge in sequence until the whole cartridge bank is used up. The microprocessor also sends the status information about the metal-emulsion content to the LCD display screen, 6. It also gives a warning signal, an audible tone with a warning message on the display, to alert the automobile or motor vehicle driver to prepare for a refill. The cartridge bank is built as one rigid unit, which can be easily disconnected from and reattached to the system.

I claim:

1. A portable hydrogen-on-demand-generating system comprises of reacting water or alkali hydroxide with metals in the form of metal-oil emulsion. The said system can be installed on board an automobile or motor vehicle having a hydrogen powered internal combustion engine.

2. In the method in accordance with claim 1, the said metal emulsions consist of an aluminum powder-oil emulsion, or an iron powder-oil emulsion, or one of the emulsions of finely divided sodium, or potassium, or magnesium. The size of the metallic powder could range from 25 to 500 microns.

3. In the method in accordance with claim 2, the emulsion can contain anywhere from 25% to 75% of metal by weight.

4. The metallic powder in the said metal emulsions was prepared just before the making of the emulsion to minimize the possible contamination by air and water vapor. In the method in accordance with claim 1, the metal emulsion is stored in a bank of 6 to 12 cartridges. These cartridges are arranged around a tank serving as the reactor in which the metal in the emulsion is reacting with water when sodium or potassium or magnesium is used, or reacting with alkali hydroxide solution when aluminum or iron emulsion is used.

5. In accordance with claim 5, the said reacting tank is provided with a stirrer to promote the rapid and complete reaction between the metallic powder and water or alkali hydroxide solutions.

6. In accordance with claim 1, the said emulsion has a consistency comparable to that of a tooth paste.

7. In the method in accordance with claim 5, the said reaction tank is connected with metal emulsion cartridges and a waste separating tank where oil from the metal emulsion is continuously separated from the reaction waste solution. The oil is bled into an aqueous waste storage tank.

8. The method in accordance with claim 5, the smooth and steady supply of the metal emulsion into the reactor is regulated by the pressure difference between the cartridge in use and the reactor. The pressure in the cartridge is controlled by a pressure controller (attached to the compressed air reservoir, not shown) and supplied by a compressor. When the engine is stopping, the pressure of hydrogen in the reactor is building up to equal that of the metal emulsion cartridge, hence, there is no flow of metal emulsion. When the engine is running from idle to acceleration, the hydrogen pressure in the reactor is progressively reduced, and the rate of metal emulsion flow is proportionally increased.

8. In accordance with the operation of hydrogen generation in claim 5, the system is provided with a microprocessor, which controls the hydrogen generation on demand smoothly. It controls the timely opening and closing of the delivering valve in each and every one of the cartridges in series. When one cartridge is exhausted, the delivery valve of that cartridge is closed promptly, and at the same time, the delivering valve of next cartridge is opened immediately, and so on and so forth, until all the cartridges are exhausted. The said microprocessor also measures continuously the metal emulsion content of the entire system and sends this information to the liquid crystal display.

9. In accordance with claim 5, the reacting tank is provided with an electric heater in case the metal fuel used is aluminum or iron. The temperature of the reacting tank is controlled by the microprocessor to maintain an optimal setting between room temperature and 250° C.
